(19) United States
(12) Patent Application Publication
(10) Pub. No.: US 2010/0253780 A1
(43) Pub. Date: Oct. 7, 2010

(54) VEHICLE AUXILIARY DEVICE

(76) Inventor: Shih-Hsiung LI, Taipei (TW)

Correspondence Address: PATENTTM.US, P. O. BOX 82788, PORTLAND, OR, 97282-0788, US

(21) Appl. No.: 12/418,413

(22) Filed: Apr. 3, 2009

(51) Int. Cl. H04N 7/18; B60Q 1/00

(52) U.S. Cl. 348/148; 340/441; 340/435; 348/E07.085

(57) ABSTRACT

A vehicle auxiliary device has multiple front video cameras, multiple rear video cameras, at least one roadway video camera, multiple front ultrasonic transducers, multiple rear ultrasonic transducers, a controller and at least one display. The controller is electronically connected to the front, the rear and the roadway video cameras and the front and the rear ultrasonic transducers to receive electronic signals from the front and the rear ultrasonic transducers and compute distances between the front and the rear ultrasonic transducers and the obstacles from the electronic signals. The display is electronically connected to the controller to illustrate the images captured by the front, the rear and the roadway video cameras.

### BACKGROUND OF THE INVENTION

1. Field of the Invention

The present invention relates to a vehicle auxiliary device, and more particularly to a vehicle auxiliary device that integrates video cameras and ultrasonic sensors to provide visual images of traffic conditions and an audio warning to drivers so as to increase traffic safety.

2. Description of Related Art

In order to assist a driver to easily park a vehicle, a parking sensor apparatus is invented, is mounted on the vehicle rear and has multiple ultrasonic transducers, a control unit and a buzzer. The ultrasonic transducers are disposed on the rear bumper of the vehicle to emit ultrasonic waves and receive ultrasonic waves reflected by obstacles. The control unit is electronically connected to the ultrasonic transducers to receive the reflected ultrasonic wave and compute a distance from the obstacle. The buzzer is electronically connected to and is driven by the control unit to sound alarm when the obstacle is detected. Furthermore, the control unit drives the buzzer to sound alarms in different frequencies to present different distances from the vehicle to the obstacle.

To make the driver park vehicle more easily, a conventional visual auxiliary device for the vehicle is invented and comprises a video camera and a display. The video camera is disposed on the vehicle rear to capture images behind the vehicle. The display is disposed inside the vehicle and is electronically connected to the video camera to illustrate video images captured by the video camera. Therefore, when the driver parks the vehicle, the driver easily avoids hitting the obstacle by watching image shown in the display. Accordingly, some vehicle auxiliary device comprises the parking sensor apparatus and the visual auxiliary device to increase parking safety by sounding an alarm and displaying the images behind the vehicle at the same time to warn the driver.

Furthermore, some traffic conditions cannot be detected by the foregoing conventional auxiliary device for vehicles. With reference to FIG. 7, a first vehicle (51) is drove in a narrow alley and approaches the intersection of the narrow alley and a crossroad. The driver in the first vehicle (51) cannot see the traffic conditions on the crossroad because the vehicle head is often separated from the driver by a distance. Once a second vehicle (52) approaches the intersection of the narrow lane and the crossroad, the driver in the first vehicle (51) could miss the second vehicle (52) so a series accident happens.

Moreover, with reference to FIG. 8, when a third vehicle (70) backs out from a parking space along a backing route, the driver in the third vehicle (70) conventionally monitor the traffic conditions behind the third vehicle (70) with a left and a right side mirrors (71, 72). However, because the range of visibility of the driver in the third vehicle (70) (slash lines) is blocked by adjacent vehicles, the driver in the third vehicle (70) cannot correctly monitor any other vehicle approaching the backing route of the third vehicle (70).

In addition, holes are often excavated during construction of roadways. Once the holes are not filled up, passengers in the vehicle could feel uncomfortable or an accident could happen when vehicle is drove through the unfilled up holes.

To overcome the shortcomings, the present invention provides a vehicle auxiliary device to mitigate or obviate the aforementioned problems.

### SUMMARY OF THE INVENTION

The main objective of the invention is to provide a vehicle auxiliary device that uses video cameras and ultrasonic sensors to integrate visual images and reflected ultrasonic waves to provide a vehicle driver effective information about different traffic conditions.

The vehicle auxiliary device in accordance with the present invention is disposed on a vehicle having a head, a rear and a gear and comprises:

multiple front video cameras disposed on the head of the vehicle to capture images in front of the vehicle;

multiple rear video cameras disposed on the rear of the vehicle to capture images behind the vehicle;

at least one roadway video camera installed on the head of the vehicle to capture images of the roadway in front of the vehicle;

multiple front ultrasonic transducers disposed on the head of the vehicle and outputting electronic signals corresponding to distances from obstacles;

multiple rear ultrasonic transducers disposed on the rear of the vehicle and outputting electronic signals corresponding to distances from obstacles;

a controller disposed in the vehicle, electronically connected to the front video cameras, the rear video cameras, the roadway video camera, the front ultrasonic transducers and the rear ultrasonic transducers to receive electronic signals from the front and the rear ultrasonic transducers and compute distances between the front and the rear ultrasonic transducers and the obstacles from the electronic signals and having a speed detection terminal and a gear detection terminal, wherein the speed detection terminal and the gear detection terminal are used respectively to retrieve speed and gear shifting conditions of the vehicle; and

at least one display electronically connected to the controller to illustrate the images captured by the front, the rear and the roadway video cameras.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of a first embodiment of a vehicle auxiliary device in accordance with the present invention;

FIG. 2 is a front view of a display of the vehicle auxiliary device in FIG. 1 with images captured by the front and the rear video cameras;

FIG. 3 is a front view of a display of the vehicle auxiliary device in FIG. 1 with images captured by the front and the rear video cameras and graphical numbers and characters representing distances;

FIG. 4 is a front view of a display of the vehicle auxiliary device in FIG. 1 with images captured by the front and the rear video cameras and images presenting statuses of ultrasonic transducers;

FIG. 5 shows a top view of the vehicle with the vehicle auxiliary device in FIG. 1 is in a narrow alley and approaches the intersection of the narrow alley and a crossroad;

FIG. 6 shows a top view of the vehicle with the vehicle auxiliary device in FIG. 1 backs out from a parking space;

FIG. 7 a top view of a vehicle with a conventional vehicle auxiliary device is in a narrow alley and approaches the intersection of the narrow alley and a crossroad; and

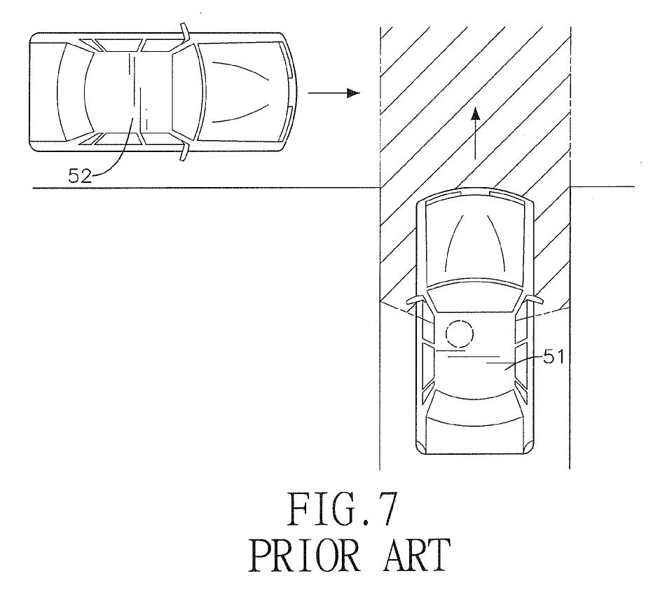

FIG. 8 shows a top view of a vehicle with a conventional vehicle auxiliary device backs out from a parking space.

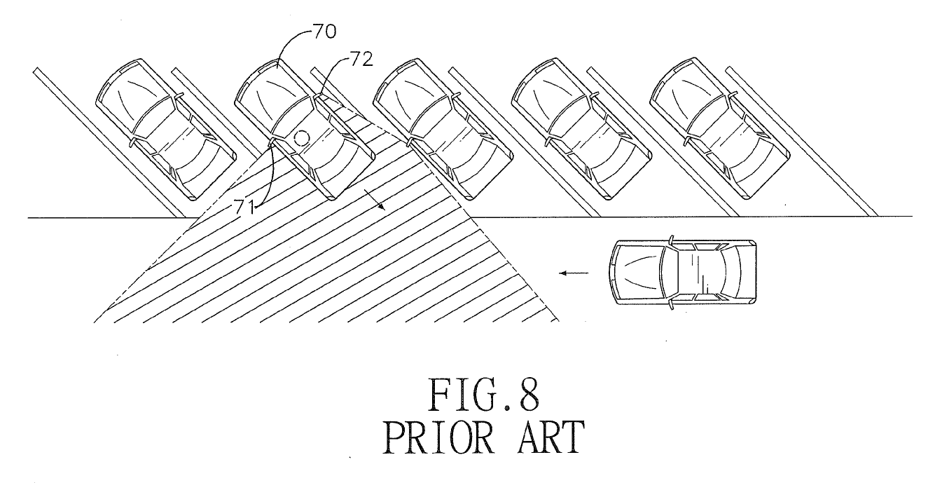

### DETAILED DESCRIPTION OF THE PREFERRED EMBODIMENT

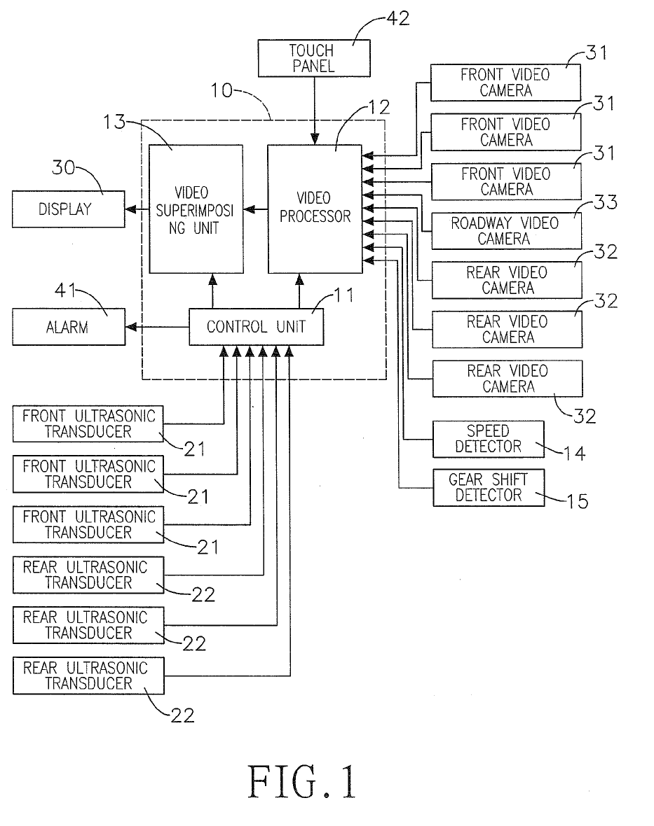

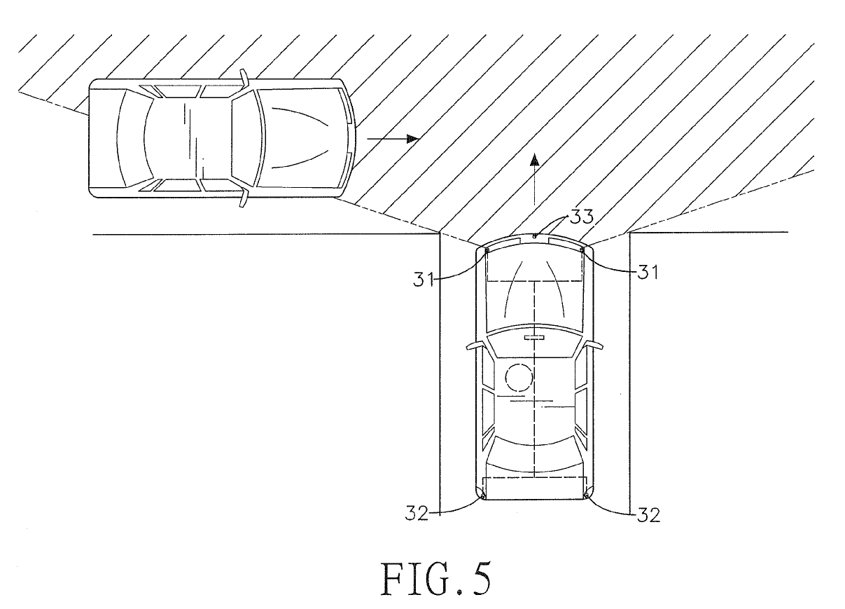

With reference to FIGS. 1 and 5, a vehicle auxiliary device in accordance with the present invention is disposed on a vehicle. The vehicle has a head, a rear and a gear. The vehicle auxiliary device comprises multiple front video cameras (31), multiple rear video cameras (32), at least one roadway video camera (33), multiple front ultrasonic transducers (21), multiple rear ultrasonic transducers (22), an optional speed detector (14), an optional gear shifting detector (15), a controller (10), at least one display (30), an optional alarm (41) and an optional touch panel (42).

The front video cameras (31) are disposed on the head of the vehicle. In the preferred embodiment, there are two front video cameras (31) disposed respectively on the right and the left of the head of the vehicle. Therefore, the two front video cameras (31) captures images in front of the head of the vehicle.

The rear video cameras (32) are disposed on the rear of the vehicle. In the preferred embodiment, there are two rear video cameras (32) disposed respectively on the right and the left of the rear of the vehicle. Therefore, the two rear video cameras (32) capture images behind the rear of the vehicle.

Each roadway video camera (33) is disposed on the middle of the head of the vehicle to capture images of the roadway in front of the vehicle.

The front ultrasonic transducers (21) are disposed on the head of the vehicle. The rear ultrasonic transducers (22) are disposed on the rear of the vehicle. Firstly, each ultrasonic transducer (21, 22) emits ultrasonic waves. The ultrasonic waves are transmitted in the air with a speed of 340 meters per second. If an obstacle is at transmitting paths of the ultrasonic waves, the ultrasonic waves will be reflected by the obstacles. The reflected ultrasonic waves are then received by the ultrasonic transducers (21, 22). Therefore, The ultrasonic transducers (21, 22) output electronic signals corresponding to the received ultrasonic waves.

The speed detector (14) and the gear shifting detector (15) are disposed in the vehicle to respectively detect speed and gear shifting conditions of the vehicle.

The controller (10) is disposed in the vehicle, is electronically connected to the front video cameras (31), the rear video cameras (32), the roadway video camera (33), the front ultrasonic transducers (21) and the rear ultrasonic transducers (22) to receive electronic signals from the front and the rear ultrasonic transducers (21, 22) and compute distances between the front and the rear ultrasonic transducers (21, 22) and the obstacles from the electronic signals, has a speed detection terminal and a gear detection terminal and may further comprise a control unit (11), a video processor (12) and a video superimposing unit (13).

The speed detection terminal and the gear detection terminal are connected respectively to the speed detector (14) and the gear shifting detector (15) to retrieve speed and gear shifting conditions of the vehicle.

The control unit (11) has multiple input terminals and multiple output terminals. The input terminals of the control unit (11) are electronically connected to the front and the rear ultrasonic transducers (21, 22).

The video processor (12) has multiple input terminals and at least one output terminal. The input terminals of the video processor (12) are electronically connected to the speed detection terminal and the gear detection terminal of the controller (10), the front and rear video cameras (31, 32), the roadway video camera (33) and one of the output terminals of the control unit (11). Therefore, the control unit (11) retrieves and determines the speed and gear shifting conditions of the vehicle from the speed detector (14) and the gear shifting detector (15) through the video processor (12), the speed detection terminal and the gear detection terminal. When the speed of the vehicle is slower than 10 kilometer per hour and the gear condition of the vehicle is shifted to the forward gear or stop gear, the control unit (11) controls and determines the operation sequence of the front ultrasonic transducers (21). At the same time, the control unit (11) processes the electronic signals received from the front ultrasonic transducers (21) and controls the video processor (12) to retrieve and output images captured from the front video cameras (31). In addition, when the gear condition of the vehicle is shifted to the backward gear, the control unit (11) controls and determines the operation sequence of the rear ultrasonic transducers (22). At the same time, the control unit (11) processes the electronic signals received from the rear ultrasonic transducers (22) and controls the video processor (12) to retrieve and output the images captured from the rear video cameras (32). When the handbrake of the vehicle is actuated, the control unit (11) turns the front or the rear ultrasonic transducers (21, 22) off. Furthermore, the video processor (12) may have a video strobe mode and a video dividing and composing mode.

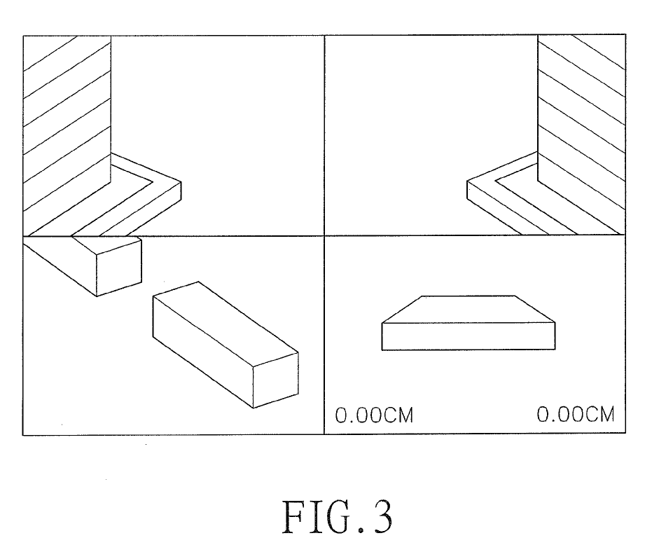

The video superimposing unit (13) is electronically connected to the output terminal of the video processor (12) and one of the output terminals of the control unit (11) to superimpose text information representing the distances between the front and the rear ultrasonic transducers (21, 22) and the obstacles on the images output from the video processor (12). A preferred embodiment of superimposing the text information on the images output from the video processor (12) is to further store graphical numbers and characters in the video superimposing unit (13). The video superimposing unit (13) decodes the images output from the video processor (12) into Y, Cb and Cr signals, superimposes the graphical numbers and characters corresponding to the distances between the front and the rear ultrasonic transducers (21, 22) and the obstacles output from the video processor (12) into the Y, Cb and Cr signals (to strengthen or weaken the strength of the Y, Cb and Cr signals) and encodes the superimposed Y, Cb and Cr signals into images. Therefore, with reference to FIG. 3, the video superimposing unit (13) superimposes the graphical numbers and characters representing the distances between the front and the rear ultrasonic transducers (21, 22) and the obstacles on the images output from the video processor (12) to provide the images in front of or behind the vehicle and the distances between the front and the rear ultrasonic transducers (21, 22) and the obstacles to the driver of the vehicle.

Each display (30) is electronically connected to the controller (10). Furthermore, when the controller (10) comprises the control unit (11), the video processor (12) and the video superimposing unit (13), each display (30) is electronically connected to the video processor (12) through the video superimposing unit (13) to display images output from the video superimposing unit (13).

The alarm (41) is electronically connected to the controller (10) and may be a buzzer or a speaker. Furthermore, when the controller (10) comprises the control unit (11), the video processor (12) and the video superimposing unit (13), the alarm (41) is electronically connected to one of the output terminals of the control unit (11) and is controlled by the control unit (11) to warn the driver of the vehicle when any distance between the front and the rear ultrasonic transducers (21, 22) and the obstacles is too short.

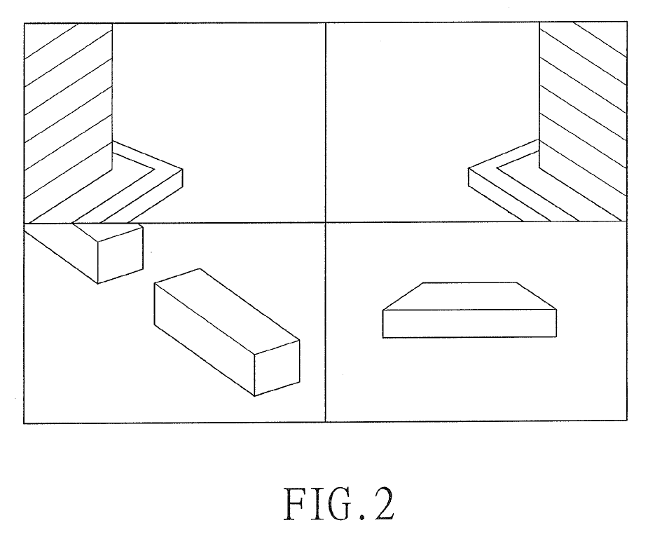

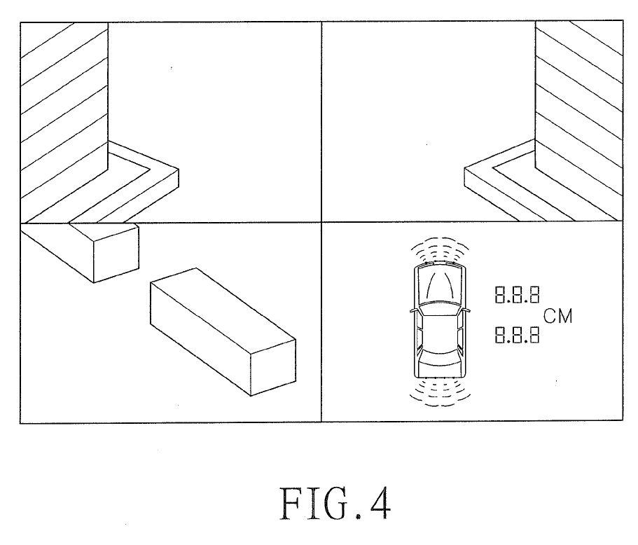

The touch panel (42) is electronically connected to the video processor (12) and may be integrated with the display (30) to allow a user to control the operation modes of the video processor (12). When the video processor (12) is operated in the video strobe mode, the user can select images captured by one of the front, the rear and the roadway video cameras (31, 32, 33) to illustrated on the display (30) with the touch panel (42). With further reference to FIG. 2, when the video processor (12) is operated in the video dividing and composing mode, the video processor (12) will compose images captured by the front, the rear and the roadway video cameras (31, 32, 33) and send the composed images to the display (30) through the video superimposing unit (13). Furthermore, the video processor (12) may generate images presenting statuses of the front and the rear ultrasonic transducers (21, 22). With reference to FIG. 4, when the video processor (12) is operated in the video dividing and composing mode, the video processor (12) may compose images captured by the front, the rear and the roadway video cameras (31, 32, 33) and the images presenting statuses of the front and the rear ultrasonic transducers (21, 22) and send the composed images to the display (30) through the video superimposing unit (13). At this moment, the video superimposing unit (13) will not superimpose text information representing the distances between the front and the rear ultrasonic transducers (21, 22) and the obstacles on the images output from the video processor (12).

The described vehicle auxiliary device has following advantages.

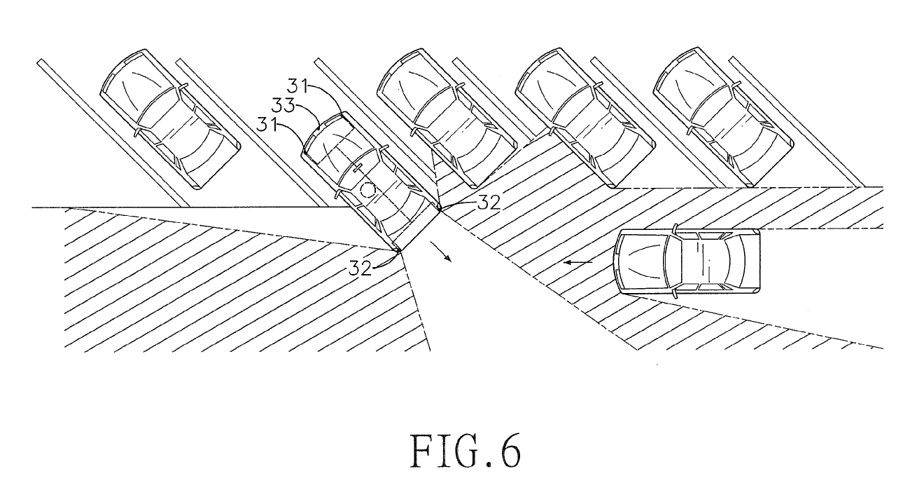

1. The images captured by the front and the rear video cameras (31, 32) are provided to extend the vision range of the driver. For example, with reference to FIG. 5, when the vehicle is drove in a narrow alley and approaches the intersection of the narrow alley and a crossroad and the images captured by the front video cameras (31) are illustrated on the display (30), the driver sees the traffic conditions on the crossroad illustrated on the display (30) to avoid crashing into another vehicle on the crossroad approaching the intersection of the narrow alley and the crossroad. In addition, with reference to FIG. 6, when the vehicle is just backed out the parking space along a backing route, the images behind the vehicle are immediately captured by the rear video cameras (32) and illustrated on the display (30). The driver watches the images illustrated on the display (30) to understand the traffic conditions.

2. When the images captured by the roadway video camera (33) are illustrated on the display (30), the driver watches the display (30) to avoid that the vehicle is drove through holes or protrusions.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A vehicle auxiliary device disposed on a vehicle having a head, a rear and a gear, the vehicle auxiliary device comprising:
multiple front video cameras disposed on the head of the vehicle to capture images in front of the vehicle;
multiple rear video cameras disposed on the rear of the vehicle to capture images behind the vehicle;
at least one roadway video camera installed on the head of the vehicle to capture images of the roadway in front of the vehicle;
multiple front ultrasonic transducers disposed on the head of the vehicle and outputting electronic signals corresponding to distances from obstacles;
multiple rear ultrasonic transducers disposed on the rear of the vehicle and outputting electronic signals corresponding to distances from obstacles;
a controller disposed in the vehicle, electronically connected to the front video cameras, the rear video cameras, the roadway video camera, the front ultrasonic transducers and the rear ultrasonic transducers to receive electronic signals from the front and the rear ultrasonic transducers and compute distances between the front and the rear ultrasonic transducers and the obstacles from the electronic signals and having a speed detection terminal and a gear detection terminal, wherein the speed detection terminal and the gear detection terminal are used respectively to retrieve speed and gear shifting conditions of the vehicle; and
at least one display electronically connected to the controller to illustrate the images captured by the front, the rear and the roadway video cameras.

2. The vehicle auxiliary device as claimed in claim 1 further comprising an alarm, wherein:
the controller further comprises:
a control unit having
multiple input terminals electronically connected to the front and the rear ultrasonic transducers; and
multiple output terminals;
a video processor having
multiple input terminals electronically connected to the speed detection terminal and the gear detection terminal of the controller, the front and rear video cameras, the roadway video camera and one of the output terminal of the control unit; and
at least one output terminal; and
a video superimposing unit electronically connected to the output terminal of the video processor and one of the output terminals of the control unit to superimpose text information representing the distances between the front and the rear ultrasonic transducers and the obstacles on the images illustrated on the display; and
the alarm is electronically connected to and is controlled by the controller.

3. The vehicle auxiliary device as claimed in claim 2 further comprising a touch panel electronically connected to the video processor in the controller.

4. The vehicle auxiliary device as claimed in claim 3, wherein the touch panel is integrated with the display.

5. The vehicle auxiliary device as claimed in claim 2 further comprising a speed detector and a gear shifting detector, wherein:
the speed detector and the gear shifting detector are disposed in the vehicle to respectively detect speed and gear shifting conditions of the vehicle; and
the speed detection terminal and the gear detection terminal of the controller retrieve the speed and gear shifting conditions of the vehicle respectively from the speed detector and the gear shifting detector.

6. The vehicle auxiliary device as claimed in claim 2, wherein the alarm is a buzzer.

7. The vehicle auxiliary device as claimed in claim 2, wherein the alarm is a speaker.
